(19) United States
(12) Patent Application Publication
(10) Pub. No.: US 2005/0106464 A1
(43) Pub. Date: May 19, 2005

(54) Lithium secondary battery

(76) Inventors: Toshikazu Yoshida, Kobe-city (JP); Nobuhiro Sakitani, Kobe-city (JP); Maruo Kamino, Itano-gun (JP); Hasaki Tarui, Kobe-city (JP)

Correspondence Address: KUBOVCIK & KUBOVCIK, SUITE 710, 900 17TH STREET NW, WASHINGTON, DC, 20006, US

(21) Appl. No.: 10/991,927

(22) Filed: Nov. 19, 2004

(30) Foreign Application Priority Data
Nov. 19, 2003 (JP) 2003-389845

(51) Int. Cl. H01M 4/58; H01M 4/64

(52) U.S. Cl. 429/231.95; 429/233

(57) ABSTRACT

Charge-discharge cycle performance is improved in a lithium secondary battery that uses a material that occludes lithium by alloying with lithium as its negative electrode active material. A lithium secondary battery comprises a negative electrode having a negative electrode active material thin film provided on a negative electrode current collector, a positive electrode including a positive electrode active material, and a non-aqueous electrolyte, in which the negative electrode active material is a material that occludes lithium by alloying with lithium, the ratio of the discharge capacity per unit area of the negative electrode to the discharge capacity per unit area of the positive electrode is from 1.5 to 3, and the ratio of the thickness (μm) of the negative electrode active material to the arithmetical mean roughness Ra (μm) of the surface of the negative electrode current collector is 50 or less.

### BACKGROUND OF THE INVENTION

1. Field of the Invention

The present invention relates to a lithium secondary battery comprising a positive electrode, a negative electrode, and a non-aqueous electrolyte, and more particularly to a lithium secondary battery using, as a negative electrode active material, a material that occludes lithium by alloying with lithium.

2. Description of Related Art

Lithium secondary batteries using a non-aqueous electrolyte and performing a charge-discharge operation by shifting lithium ions between positive and negative electrodes have been utilized in recent years as a new type of high power, high energy density secondary battery.

As for electrodes for such lithium secondary batteries, some research has been conducted on electrodes that use a material capable of alloying with lithium as its negative electrode active material. One example of the material capable of alloying with lithium that has been studied is silicon. However, a problem with the material capable of alloying with lithium such as silicon has been that the volume of the active material expands and shrinks when it absorbs (intercalates) and desorbs (deintercalates) lithium, causing the active material to pulverize or peel off from the current collector as the charge-discharge process is repeated. As a consequence, the current collection performance in the electrode reduces, degrading the battery's charge-discharge cycle performance.

The present applicant has found that an electrode formed by depositing on a current collector an active material thin film that absorbs and desorbs lithium, such as an amorphous silicon thin film or a microcrystalline silicon thin film, shows high charge-discharge capacity and good charge-discharge cycle performance. (See International Publication WO 01/29913).

In this type of electrode, the active material thin film is divided into columnar structures by grooves formed along its thickness, and bottom portions of the columnar structures are in close contact with the current collector. In the electrode with such a structure, gaps form around the columnar structures. These gaps alleviate a stress caused by the expansion and shrinkage of the thin film associated with charge-discharge cycles and prevent the occurrence of stress that causes the active material thin film to peel off from the current collector. Therefore, such an electrode can attain good charge-discharge cycle performance.

Nevertheless, further improvement in the cycle performance has been desired for lithium secondary batteries using the above-described electrode as its negative electrode.

### BRIEF SUMMARY OF THE INVENTION

Accordingly, it is an object of the present invention to provide a lithium secondary battery using a material that occludes lithium by alloying with lithium as its negative electrode active material, and having good charge-discharge cycle performance.

In order to accomplish the foregoing and other objects, the present invention provides a lithium secondary battery comprising: a negative electrode having a negative electrode active material thin film provided on a negative electrode current collector; a positive electrode including a positive electrode active material; and a non-aqueous electrolyte; wherein the negative electrode active material is a material that occludes lithium by alloying with lithium, the ratio of the discharge capacity per unit area of the negative electrode to the discharge capacity per unit area of the positive electrode is from 1.5 to 3, and the ratio of the thickness (μm) of the negative electrode active material thin film to the arithmetical mean roughness Ra (μm) of the surface of the negative electrode current collector is 50 or less.

In the present invention, the ratio of the discharge capacity per unit area of the negative electrode to the discharge capacity per unit area of the positive electrode (hereafter referred to as “negative electrode/positive electrode capacity ratio”) is from 1.5 to 3. By restricting the negative electrode/positive electrode capacity ratio within such a range, good cycle performance is attained. If the negative electrode/positive electrode capacity ratio is less than 1.5, good cycle performance, which is an advantageous effect of the present invention, cannot be attained. If the negative electrode/positive electrode capacity ratio exceeds 3, the energy density of the lithium secondary battery becomes low, which is undesirable.

Discharge capacity per unit area of a positive electrode or a negative electrode can be measured by using a test cell in which a lithium metal electrode and an electrode that is the subject of measurement are opposed with a separator of a microporous polyethylene film or the like interposed therebetween. The non-aqueous electrolyte for the test cell is that in which LiPF₆ is dissolved at a concentration of 1 mole/liter into a mixed solvent in which ethylene carbonate and diethyl carbonate are mixed at a volume ratio of 1:1. The charge-discharge ranges are 4.3-2.75 V vs. Li/Li⁺ for the positive electrode and 0-2 V vs. Li/Li⁺ for the negative electrode, respectively.

Moreover, in the present invention, the ratio of the thickness (μm) of the negative electrode active material to the arithmetical mean roughness Ra (μm) of the surface of the negative electrode current collector is 50 or less. By setting such a range, good cycle performance can be obtained. In the present invention, it is preferable that arithmetical mean roughness Ra of the negative electrode current collector surface be within the range of 0.1-1.0 μm, more preferably within the range of 0.2-0.7 μm, and still more preferably within the range of 0.2-0.5 μm. Arithmetical mean roughness Ra is defined in Japanese Industrial Standard (JIS) B 0601-1994, and it can be measured by a surface roughness meter or a laser microscope. In the examples of the present specification, the measurement is carried out with a laser microscope OLS1100 (made by Olympus Corp.).

The negative electrode active material in the present invention is a material that occludes lithium by alloying with lithium. Examples of such a material include silicon, tin, aluminum, and germanium. It is preferable that the negative electrode active material thin film be formed by depositing a negative electrode active material on a current collector by a thin-film forming technique. Examples of the thin-film forming technique include CVD, sputtering, vacuum deposition, and thermal spraying. Alternatively, the thin film may be formed by electroplating, electroless plating, or the like.

In the present invention, it is preferable that the negative electrode active material thin film be divided into columnar structures by grooves formed along its thickness, and bottom portions of the columnar structures be in close contact with the negative electrode current collector. Such grooves are formed by the expansion and shrinkage of the volume of the thin film due to charge-discharge reaction. Thus, it is preferable that irregularities corresponding to irregularities in the current collector surface are formed in the thin film surface, and the grooves be formed in the regions that join the valleys of the irregularities in the thin film and the valleys of the irregularities in the current collector. Since such grooves create gaps around the columnar structures, these surrounding gaps absorb expansion and shrinkage of the volume of the thin film caused by the charge-discharge reaction, suppressing stress from occurring in the thin film. This makes it possible to prevent the thin film from peeling off from the current collector.

In the present invention, the negative electrode/positive electrode capacity ratio is set to 1.5 or greater to restrict the expansion and shrinkage of the volume of the active material thin film due to the charge-discharge reaction in the negative electrode, and thereby the charge-discharge cycle performance is further improved. In addition, by restricting the ratio of the thickness of the negative electrode active material thin film to the arithmetical mean roughness Ra (μm) of the surface of the current collector to 50 or less and, preferably, 25 to 50, a stress caused in the thin film is further reduced, and the charge-discharge cycle performance is further improved.

In the present invention, it is preferable that the negative electrode active material thin film be an amorphous thin film. When the negative electrode active material is silicon, it is preferable that the negative electrode active material thin film be an amorphous silicon thin film or a microcrystalline silicon thin film.

The positive electrode active material in the present invention is not particularly limited as long as the positive electrode active material can be used for a lithium secondary battery, and it is possible to use various positive electrode active materials that have conventionally been known for such use. Specific examples that can be used include manganese dioxide, lithium-containing manganese oxide, lithium-containing cobalt oxide, lithium-containing vanadium oxide, lithium-containing nickel oxide, lithium-containing iron oxide, lithium-containing chromium oxide, and lithium-containing titanium oxide.

As the solvent of the non-aqueous electrolyte in the present invention, any solvent may be used with no particular restriction as long as it can be used for lithium secondary batteries. Examples include: a mixed solvent in which a cyclic carbonic ester such as ethylene carbonate, propylene carbonate, butylene carbonate, or vinylene carbonate is mixed with a chain carbonic ester such as dimethyl carbonate, methyl ethyl carbonate, or diethyl carbonate; and a mixed solvent in which any of the above-listed cyclic carbonic esters is mixed with an ether such as 1,2-dimethoxyethane or 1,2-diethoxyethane.

For the solute of the non-aqueous electrolyte in the present invention, any solute may be used with no restriction as long as it can be used for a lithium secondary battery. Examples include: LiXFₚ (wherein X is P, As, Sb, Al, B, Bi, Ga, or In; p is 6 when X is P, As, or Sb; and p is 4 when X is Al, B, Bi, Ga, or In); LiCF₃SO₃; LiN(CₘF₂ₘ₊₁SO₂)(CₙF₂ₙ₊₁SO₂)(wherein m=1, 2, 3, or 4 and n=1, 2, 3, or 4); LiC(CₗF₂ₗ₊₁SO₂)(CₘF₂ₘ₊₁SO₂)(CₙF₂ₙ₊₁SO₂) (wherein 1=1, 2, 3, or 4; m=1, 2, 3, or 4; and n=1, 2, 3, or 4); and mixtures thereof.

Also usable as the non-aqueous electrolyte is a gelled polymer electrolyte in which a non-aqueous electrolyte is impregnated in a polymer such as polyethylene oxide or polyacrylonitrile.

According to the present invention, charge-discharge cycle performance can be improved in a lithium secondary battery using as its negative electrode active material a material that occludes lithium by alloying with lithium.

### BRIEF DESCRIPTION OF THE DRAWINGS

FIG. 1 is a front view of a lithium secondary battery fabricated in an example of the present invention; and

FIG. 2 is a cross-sectional view showing an electrode structure of a lithium secondary battery fabricated in an example of the present invention.

### DETAILED DESCRIPTION OF THE PREFERRED EMBODIMENTS

Hereinbelow, preferred embodiments of the present invention are described by way of examples thereof. It should be construed, however, that the present invention is not limited to the following examples but various changes and modifications are possible unless such changes and variations depart from the scope of the invention.

### EXAMPLE 1

Preparation of Negative Electrode

Using a copper foil on one side of which is formed irregularities (thickness=20 μm, arithmetical mean roughness Ra of the irregular surface=0.2 μm) as a current collector, a silicon thin film was formed on the irregular surface of the current collector by RF sputtering. The conditions of the sputtering were as follows; sputtering (Ar) flow rate=100 sccm, substrate temperature=room temperature (not heated), reaction pressure=1.0×10⁻³ Torr, and high-frequency power=200 W. The silicon thin film was deposited until its thickness became 5 μm. This silicon thin film was confirmed to be amorphous by XRD.

In the manner described above, an electrode having a size of 2 cm×2 cm was prepared. The discharge capacity per unit area of this electrode was 3.93 mAh/cm².

Preparation of Positive Electrode

A slurry was prepared by mixing NMP (N-methyl-2-pyrrolidone) with 85 parts by weight of LiCoO₂ powder as a positive electrode active material, 10 parts by weight of carbon powder as a conductive agent, and 5 parts by weight of poly(vinylidene fluoride) powder as a binder agent, and the resultant slurry was coated on one side of an aluminum foil as a current collector having a thickness of 20 μm by doctor blading to form an active material layer. Thereafter, drying was carried out at 150° C., and a positive electrode having a size of 2 cm×2 cm was thus prepared. The discharge capacity per unit area of this electrode was 2.60 mAh/cm².

Preparation of Electrolyte Solution

LiPF₆ was dissolved at a concentration of 1 mole/liter into a mixed solvent in which ethylene carbonate and diethyl carbonate are mixed at a volume ratio of 1:1. An electrolyte solution was thus prepared.

Preparation of Lithium Secondary Battery

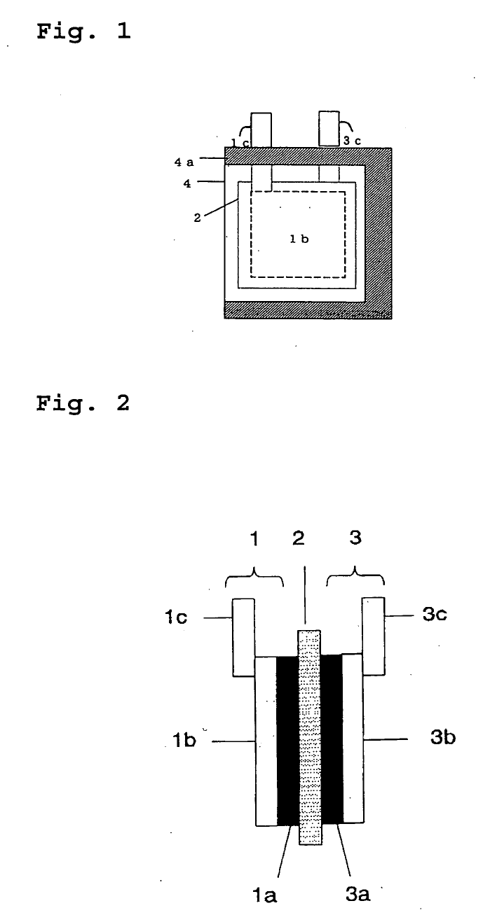

Using the negative electrode, the positive electrode, and the non-aqueous electrolyte thus prepared, a small-sized laminate battery was fabricated. FIG. 1 is a front view showing a lithium secondary battery as thus fabricated. FIG. 2 is a cross-sectional view showing the electrode structure in the lithium secondary battery. As illustrated in FIG. 2, the positive electrode 1 and the negative electrode 3 are arranged so as to oppose each other with a separator 2 interposed therebetween. For the separator 2, a microporous polyethylene film was used. In the positive electrode 1, a positive electrode active material layer 1a is formed on a positive electrode current collector 1b. In the negative electrode 3, a negative electrode active material layer 3a is formed on a negative electrode current collector 3b. a positive electrode tab 1c is attached to the positive electrode current collector 1b, and a negative electrode tab 3c is attached to the negative electrode current collector 3b.

The above-described electrodes were inserted into an outer case 4, as shown in FIG. 1. The positive electrode tab 1c and the negative electrode 3c are extended out of the outer case 4, and the periphery of the outer case 4 is sealed by a sealing part 4a.

### EXAMPLE 2

An electrode was prepared in the same manner as in Example 1 except that the thickness of the silicon thin film was 6.7 μm. The discharge capacity per unit area of this electrode was 5.26 mAh/cm². Using this electrode as a negative electrode, a lithium secondary battery was fabricated in the same manner as in Example 1.

### EXAMPLE 3

An electrode was prepared in the same manner as in Example 1 except that the thickness of the silicon thin film was 10 μm. The discharge capacity per unit area of this electrode was 7.86 mAh/cm². Using this electrode as a negative electrode, a lithium secondary battery was fabricated in the same manner as in Example 1.

### COMPARATIVE EXAMPLE 1

An electrode was prepared in the same manner as in Example 1 except that the thickness of the silicon thin film was 3.5 μm. The discharge capacity per unit area of this electrode was 2.74 mAh/cm². Using this electrode as a negative electrode, a lithium secondary battery was fabricated in the same manner as in Example 1.

### COMPARATIVE EXAMPLE 2

An electrode was prepared in the same manner as in Example 1 except that the thickness of the silicon thin film was 11 μm. The discharge capacity per unit area of this electrode was 8.65 mAh/cm². Using this electrode as a negative electrode, a lithium secondary battery was fabricated in the same manner as in Example 1.

Charge-Discharge Test

Each of the batteries was constant-current-charged at 9 mA to 4.2 V at 25° C., and thereafter constant-voltage-charged to 0.45 mA. Thereafter each cell was discharged at 9 mA to 2.75 V. This charge-discharge process was taken as 1 cycle and the charge-discharge cycle was repeated 50 times. Then, capacity retention ratio (%) at the 50th cycle, defined by the following equation, was obtained. The capacity retention ratios of the batteries are set forth in Table 1.
Capacity retention ratio (%)=(Discharge capacity at 50th cycle)/(Discharge capacity at first cycle)×100

TABLE 1

| | | Negative | | |
|---|---|---|---|---|
| | | electrode/ | | |
| | Silicon thin | positive | Silicon thin | Capacity |
| | film | electrode | film | Retention |
| | thickness | capacity | thickness/ | ratio |
| | (μm) | ratio | Ra | (%) |
| Comparative | 3.5 | 1.05 | 17.5 | 87 |
| Example 1 | | | | |
| Example 1 | 5 | 1.5 | 25.0 | 93 |
| Example 2 | 6.7 | 2 | 33.5 | 96 |
| Example 3 | 10 | 3 | 50.0 | 93 |
| Comparative | 11 | 3.3 | 55.0 | 86 |
| Example 2 | | | | |

As shown in Table 1, the lithium secondary batteries of Examples 1 to 3, the negative electrode/positive electrode capacity ratios of which were set to be within the range of 1.5 to 3 according to the present invention, exhibited superior cycle performance to the lithium secondary batteries of Comparative Examples 1 and 2. It is believed that the lithium secondary battery of Comparative Example 1, which had a negative electrode/positive electrode capacity ratio of less than 1.5, showed poor cycle performance because of degradation of silicon, which is the active material. On the other hand, it is believed that the lithium secondary battery of Comparative Example 2, which had a negative electrode/positive electrode capacity ratio of greater than 3, showed poor cycle performance because the active material thin film fell off from the current collector, causing the capacity to be reduced, due to the fact that its ratio of silicon thin film thickness/Ra exceeded 50.

### EXAMPLE 4

A negative electrode was prepared in the same manner as in Example 1, and a positive electrode was prepared so that the negative electrode/positive electrode capacity ratio became 2 with the negative electrode prepared. Using the positive electrode and the negative electrode thus prepared, a lithium secondary battery was fabricated in the same manner as in Example 1. The positive electrode discharge capacity per unit area was 1.95 mAh/cm², and the negative electrode discharge capacity per unit area was 3.93 mAh/cm².

### EXAMPLE 5

A negative electrode was prepared in the same manner as in Example 1 except that the silicon thin film thickness in the negative electrode was 10.0 μm. A positive electrode was prepared so that the negative electrode/positive electrode capacity ratio became 2 with the negative electrode prepared. Using the positive electrode and the negative electrode thus prepared, a lithium secondary battery was fabricated in the same manner as in Example 1. The positive electrode discharge capacity per unit area was 3.93 mAh/cm², and the negative electrode discharge capacity per unit area was 7.86 mAh/cm².

### EXAMPLE 6

A negative electrode was prepared in the same manner as in Example 1 except that a copper foil having a surface arithmetical mean roughness Ra of 0.12 μm was used as a current collector. Using the negative electrode thus prepared and the positive electrode of Example 1, a lithium secondary battery was fabricated. The positive electrode discharge capacity per unit area was 2.60 mAh/cm², and the negative electrode discharge capacity per unit area was 3.93 mAh/cm².

### COMPARATIVE EXAMPLE 3

A negative electrode was prepared in the same manner as in Example 1 except that the silicon thin film thickness in the negative electrode was 11.0 μm. A positive electrode was prepared so that the negative electrode/positive electrode capacity ratio became 2 with the negative electrode prepared. Using the positive electrode and the negative electrode thus prepared, a lithium secondary battery was fabricated in the same manner as in Example 1. The positive electrode discharge capacity per unit area was 4.33 mAh/cm², and the negative electrode discharge capacity per unit area was 8.65 mAh/cm².

### COMPARATIVE EXAMPLE

A negative electrode was prepared in the same manner as in Example 1 except that a copper foil having a surface arithmetical mean roughness Ra of 0.12 μm was used as a current collector and the silicon thin film thickness in the negative electrode was 6.7 μm. A positive electrode was prepared so that the negative electrode/positive electrode capacity ratio became 2 with the negative electrode prepared. Using the positive electrode and the negative electrode thus prepared, a lithium secondary battery was fabricated in the same manner as in Example 1. The positive electrode discharge capacity per unit area was 2.60 mAh/cm², and the negative electrode discharge capacity per unit area was 5.24 mAh/cm².

Charge-Discharge Test

A charge-discharge test was carried out in the same manner as in Example 1 except for the lithium secondary batteries of Examples 4 and 5 and Comparative Example 3, and their capacity retention ratios are shown in Table 2. For the lithium secondary batteries of Examples 4 and 5, a charge-discharge operation was carried out so that the charge-discharge rate became the same as that in Example 1. Specifically, the battery of Example 4 was constant-current-charged at 6.5 mA to 4.2 V at 25° C., thereafter constant-voltage-charged to 0.325 mA, and then discharged at 6.5 mA to 2.75 V. This process was defined as 1 cycle. The battery of Example 5 was constant-current-charged at 13 mA to 4.2 V at 25° C., thereafter constant-voltage-charged to 0.65 mA, and discharged at 13 mA to 2.75 V. This process was defined as 1 cycle. The battery of Comparative Example 3 was constant-current-charged at 15 mA to 4.2 V at 25° C., thereafter constant-voltage-charged to 0.75 mA, and discharged at 15 mA to 2.75 V. This process was defined as 1 cycle. The capacity retention ratios at cycle 50 of the batteries are shown in Table 2. Table 2 also shows the results for Examples 1 and 2.

TABLE 2

| | | | Negative | | |
|---|---|---|---|---|---|
| | | | electrode/ | | |
| | | Silicon | positive | Silicon thin | Capacity |
| | | thin film | electrode | film | Retention |
| | Ra | thickness | capacity | thickness/ | ratio |
| | (μm) | (μm) | ratio | Ra | (%) |
| Example 4 | 0.2 | 5.0 | 2 | 25.0 | 97 |
| Example 2 | 0.2 | 6.7 | 2 | 33.5 | 96 |
| Example 5 | 0.2 | 10.0 | 2 | 50.0 | 92 |
| Example 1 | 0.2 | 5.0 | 1.5 | 25.0 | 93 |
| Example 6 | 0.12 | 5.0 | 1.5 | 41.7 | 91 |
| Comparative | 0.2 | 11.0 | 2 | 55.0 | 84 |
| Example 3 | | | | | |
| Comparative | 0.12 | 6.7 | 2 | 55.8 | 87 |
| Example 4 | | | | | |

Table 2 demonstrates that good cycle performance was obtained when the ratio of silicon thin film thickness/Ra was 50 or less. This is believed to be because, when the ratio of silicon thin film thickness/Ra exceeded 50, the stress generated in the silicon thin film due to the charge-discharge operation became great and the silicon thin film tended to easily peel off from the current collector.

Although the foregoing examples have described laminate-type lithium secondary batteries as illustrative examples, the present invention is not limited to such a battery configuration but can be applied to other lithium secondary batteries with a variety of configurations, such as a flat-shaped configuration.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and its equivalents.

1. A lithium secondary battery comprising: a negative electrode having a negative electrode active material thin film provided on a negative electrode current collector; a positive electrode including a positive electrode active material; and a non-aqueous electrolyte; wherein
the negative electrode active material is a material that occludes lithium by alloying with lithium, the ratio of the discharge capacity per unit area of the negative electrode to the discharge capacity per unit area of the positive electrode is from 1.5 to 3, and the ratio of the thickness of the negative electrode active material thin film (μm) to the arithmetical mean roughness Ra (μm) of the surface of the negative electrode current collector is 50 or less.

2. The lithium secondary battery according to claim 1, wherein the negative electrode active material thin film is divided by grooves that form along its thickness to form columnar structures, and bottom portions of the columnar structures are in close contact with the negative electrode current collector.

3. The lithium secondary battery according to claim 1, wherein the negative electrode active material thin film is an amorphous thin film.

4. The lithium secondary battery according to claim 2, wherein the negative electrode active material thin film is an amorphous thin film.

5. The lithium secondary battery according to claim 1, wherein the negative electrode active material thin film is an amorphous silicon thin film or a microcrystalline silicon thin film.

6. The lithium secondary battery according to claim 2, wherein the negative electrode active material thin film is an amorphous silicon thin film or a microcrystalline silicon thin film.
